(19) United States
(12) Patent Application Publication
(10) Pub. No.: US 2002/0059602 A1
(43) Pub. Date: May 16, 2002

(54) System and method for miniguide implementation

(75) Inventors: Douglas B. Macrae, Weston, MA (US); Thomas Edward Ward III, Weston, MA (US)

Correspondence Address: CHRISTIE, PARKER & HALE, LLP, 350 WEST COLORADO BOULEVARD, SUITE 500, PASADENA, CA, 91105, US

(73) Assignee: Index Systems, Inc.

(21) Appl. No.: 09/962,035

(22) Filed: Sep. 25, 2001

Related U.S. Application Data
(63) Continuation of application No. 09/525,826, filed on Mar. 15, 2000.
(60) Provisional application No. 60/124,414, filed on Mar. 15, 1999.

(51) Int. Cl. H04N 5/445; G06F 3/00

(52) U.S. Cl. 725/42

(57) ABSTRACT

A system and method for displaying detailed information about a currently displayed program along with a related advertisement in a miniguide overlaid on a small portion of a current television program. A viewer invokes a miniguide command using a viewer input device, such as a remote control, while watching a current television program in full screen format. In response to the miniguide command, the television system displays a portion of the television schedule information associated with the television program in an information area, and an advertisement on a panel ad window located horizontally adjacent to the information area. The advertisement displayed on the panel ad window is based on the television program being watched or customized based on viewer profile information. The viewer may interact with the advertisement by highlighting the advertisement and activating a function with respect to the highlighted advertisement. Such functions include, for instance, displaying information and/or a video clip about a product advertised on the panel ad window.

### REFERENCE TO CROSS-RELATED APPLICATIONS

This application claims the benefit of U.S. Provisional Application Ser. No. 60/124,414, filed on Mar. 15, 1999, the contents of which are incorporated herein by reference.

### FIELD OF THE INVENTION

This invention relates generally to television systems, and more particularly, to television systems capable of displaying program information in a miniguide format.

### BACKGROUND OF THE INVENTION

As video entertainment becomes increasingly sophisticated, consumers are provided with wider options to choose from. In addition to conventional broadcast television programs, a television viewer may now have access to cable television programming, digital satellite service programming, cable stereo broadcast, and conventional satellite programming. Moreover, each transmission media provides consumers with an increased number and variety of programs.

While benefitting consumers through greater selection, the array of programming available to consumers also presents a certain dilemma. Specifically, as the number of programs available to a consumer becomes large, the process of finding and navigating through an electronic program guide (EPG) for information in regards to a particular channel or program becomes increasingly onerous.

Accordingly, new and improved methods of providing program guide information have been developed. For instance, Young et al., U.S. Pat. No. 5,353,121, which is incorporated herein by reference, discloses a system and method for creating a background electronic program guide occupying a portion of the screen. The background guide is overlaid on top of a current television program. The background mode allows the viewer to manually or automatically scroll through preselected portions of a full screen guide without the need to master the advanced navigation commands of such full screen guide.

Although the background guide displayed in Young is useful, it would also desirable to display information of only the current program being watched instead of also displaying information of other programs as is done in the background guide in Young. Furthermore, it would be desirable to display a more detailed information about the present program than what is available in the background guide disclosed in Young. Such information should be accessible without leaving the current program.

### SUMMARY OF THE INVENTION

The present invention comprises a system and method for displaying detailed information about a currently displayed program along with a related advertisement, in a miniguide overlaid on a small portion of a current television program. The display of such information from the current program without having to revert to a full screen guide is especially helpful for a viewer who, when flipping through the various channels, comes upon a program about which he or she wants quick information.

In one embodiment of the invention, the system and method for miniguide implementation includes displaying a television program on the screen in a full screen format. While the television program is displayed in full screen, the viewer invokes a miniguide command using a viewer input device, such as a remote control. In response to the miniguide command, the television system displays a portion of the television schedule information associated with the television program being watched on a first area of the screen (e.g. an information box), and an advertisement on a second area of the screen (e.g. a panel ad window) located horizontally adjacent to the first area. The information in the first area and the advertisement in the second area are invoked concurrently and overlaid on a portion of the television program.

According to one aspect of the invention, the advertisement displayed on the second area is based on the television program being watched or customized based on viewer profile information. The viewer may interact with the advertisement by highlighting the advertisement and activating a function with respect to the highlighted advertisement. Such functions include, for instance, displaying information and/or a video clip about a product being advertised on the second area.

According to another aspect of the invention, the first and second areas occupy about ⅓ of a total area of the screen. Alternatively, the position and size of the first and second areas are customized by the user.

### DESCRIPTION OF THE DRAWINGS

FIG. 1 is a schematic block diagram of an interactive television schedule system including a television and a cable box according to one embodiment of the invention;

FIG. 2 is a more detailed schematic block diagram of the cable box of FIG. 1;

FIG. 3 is a more detailed schematic block diagram of the television of FIG. 1;

FIG. 4 is an illustration of an EPG screen displayed on the television system of FIG. 1; and

FIG. 5 is a schematic layout diagram of a miniguide overlaid on a current television program according to one embodiment of the invention.

### DETAILED DESCRIPTION

In general terms, the present system and method is directed to an interactive television schedule system having a television apparatus capable of displaying a miniguide with detailed information about a currently displayed program. The miniguide preferably also includes an advertisement related to the television program. The user interacts with the miniguide as he or she would with a full screen EPG. In this way, the user may obtain quick information about the program and perform other EPG functions without navigating and dealing with the complexities of a full screen EPG.

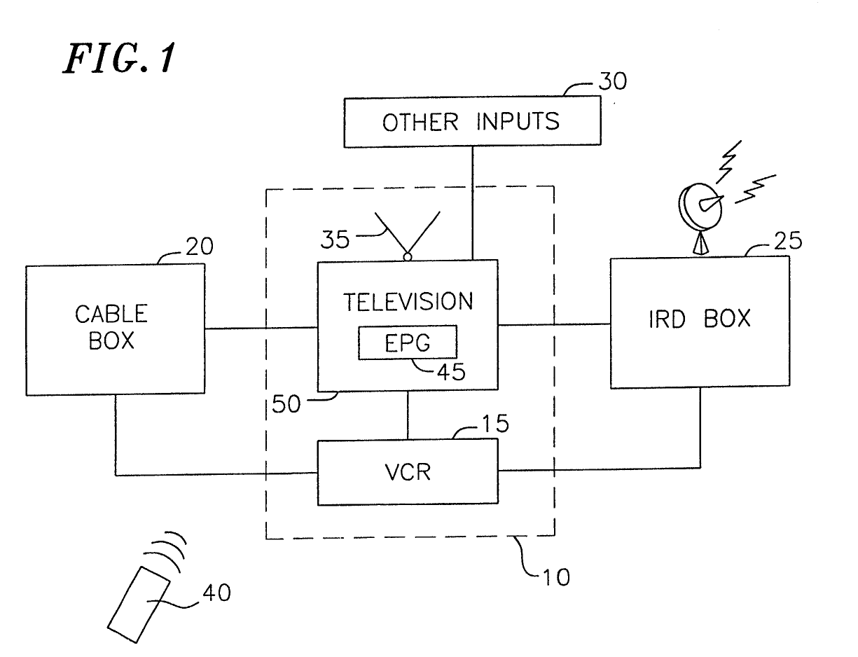

FIG. 1 is a schematic block diagram of an interactive television schedule system (television system) 10 according to one embodiment of the invention. The system includes a television 50 and a VCR 15 receiving input from a cable box 20 and an IRD box 25.

A user of the television system 10 may subscribe to and receive television programs broadcast from various television signal sources. EPG data with program scheduling information is also transmitted to the television system 10 by one or more of these signal sources. For example, EPG data may be provided via cable through the cable box 20 and/or via Direct Broadcast Satellite (DBS) through an IRD box 25. EPG data may also be received via OTA broadcast through an antenna 35 coupled to the television 50. Furthermore, the data may be transmitted through other inputs 30 such as conventional satellite systems, coax cables, telephone lines, and fiber optic cables.

The television 50 is configured with an interactive EPG 45 for displaying a merged television schedule information of television programs broadcast from the various signal sources and subscribed to by the user. The user interacts with the television 50 and EPG 45 via a viewer input device 40, preferably taking the form of an IR remote control 40, according to conventional methods. Other viewer input devices 40 might also be utilized, such as a keyboard, keypad, joystick, mouse, track ball, touch pad, and the like.

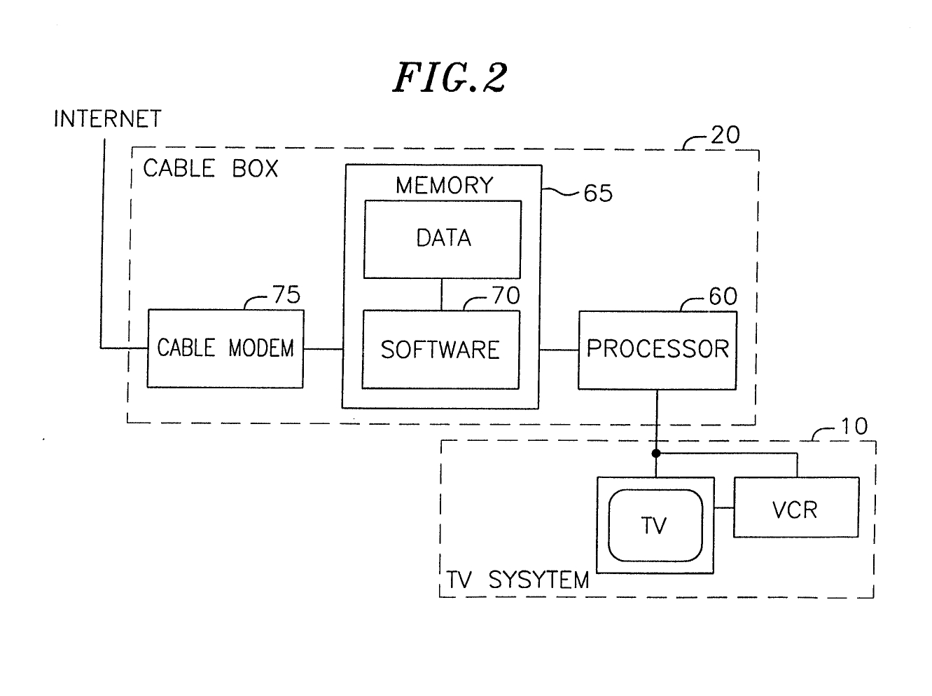

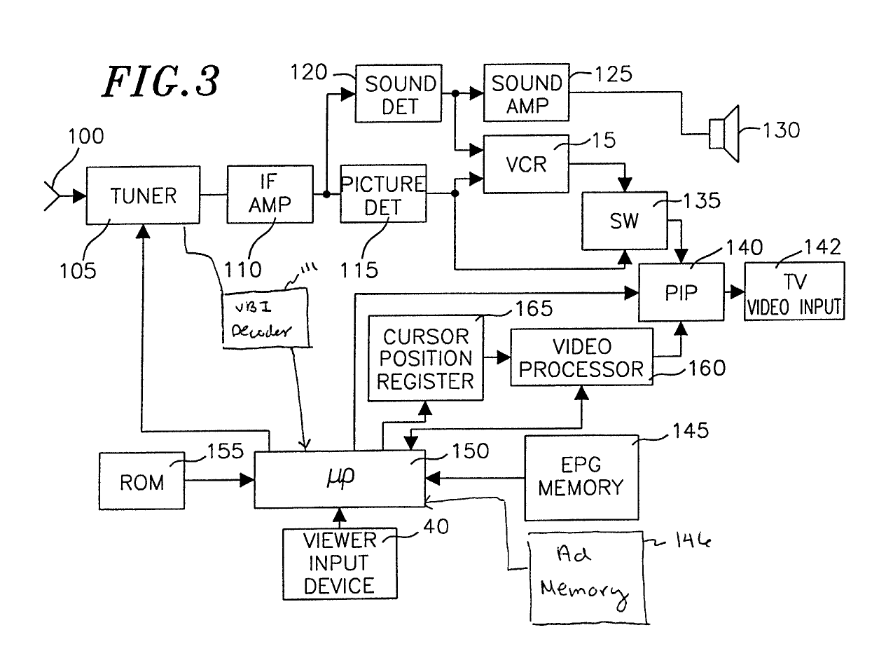

FIG. 2 is a more detailed schematic block diagram of the cable box 20 of FIG. 1 for providing EPG data to the television system 10. As illustrated in FIG. 2, the cable box 20 includes a processor 60 and a memory 65. The memory 65 of the cable box 20 stores software 70 for receiving, organizing, and displaying EPG data. The memory 65 also stores the EPG data itself. The EPG data, however, is preferably stored in a memory of the television 50 unit as is described below in conjunction with FIG. 3.

The memory 65 may further store data related to the viewer's profile and the like. In one embodiment of the invention, a portion of the data stored in the memory 65 is obtained via the Internet through a cable modem 75. Other portion of data is generated by the processor from data received from a cable head end.

FIG. 3 is a more detailed schematic block diagram of the television 50 of FIG. 1. With reference to FIG. 3, a source of television signals 100 such as the antenna 35, cable box 20, IRD box 25, or other inputs 30 carrying the television signals is connected to a television tuner 105. The output of the tuner 105 is a modulated intermediate frequency signal 110 containing video and audio television information. The tuner 105 is connected by an intermediate frequency amplifier (IF AMP) 110 to a picture detector (PICTURE DET) 115 and a sound detector (SOUND DET) 120, that produce base band video and audio signals, respectively. The audio signal is coupled by a sound amplifier (SOUND AMP) 125 to a loudspeaker 130. The video signal is coupled by a video amplifier (not shown) to one input of a switch 135. The sound detector 120 and picture detector 115 are connected to the audio and video inputs, respectively, of the VCR 15. Alternatively, television signal source 100 could be directly connected to the RF input of the VCR 15 if its internal tuner and demodulating circuitry is to be utilized.

The output of the VCR 15 is connected to the other input of the switch 135. The output of the switch 135 is connected to one input of a conventional picture-in-picture (PIP) integrated circuit chip 140. The output of the PIP chip 140 is connected to the video input 142 of the television 50 for display on a television screen (not shown).

According to one embodiment of the invention, the television 50 illustrated in FIG. 3 includes an EPG memory 145 for storing updatable databases of EPG data including the merged television program schedule information and information relating to news, sports, and local events and businesses. The databases may be updated in any one of many conventional methods, including by a continuous data link in the vertical blanking interval (VBI) of a television channel broadcast to the television system 10.

The EPG memory 145 is connected to a microprocessor 150 that is programmed to control the operation of various system devices including the television 50. An operating program for the microprocessor 150 is stored in a read only memory (ROM) 155. The viewer input device 40 is coupled to the microprocessor 150 to provide commands from the viewer and interact with the EPG.

A video processor 160 is also coupled to microprocessor 150. When the viewer invokes a miniguide command while viewing a current television program, the microprocessor 150 recalls a portion of the television program schedule information associated with the television program from the EPG memory 145 and couples it to video processor 160. The video processor formats the information for display on a portion of the screen overlaying the currently viewed program. Preferably, the information stored in the video processor 160 is a bit map of what is displayed on the screen of television 50.

The video processor 160 is further connected to the other input of the PIP chip 140. Preferably, the viewer input device 40 controls the microprocessor 150 by cursor movement on the screen of the television 50. To this end, microprocessor 150 and video processor 160 are coupled to a cursor position register 165. Alternatively, the viewer can select items of information displayed on the screen by selecting particular keys on the viewer input device 40.

A VBI decoder 111 positioned at the output of the tuner 105 extracts data detected in the VBI and couples that data to the microprocessor 150 for processing. According to one embodiment of the invention, the VBI lines transmit channel mapping information for relating channel numbers to television stations available to the user. The microprocessor 150 includes a channel mapping function that examines the channel mapping information and downloads the channel maps applicable to the user.

Referring back to the EPG memory 145, television program schedule information is stored in a program schedule database of the EPG memory. The program schedule database preferably includes the EPG data of television programs broadcast by the signal sources. The EPG data corresponding to these signal sources is then used to create a merged EPG guide for display on the television screen.

The merged EPG guide includes the program schedules of the television programs broadcast by the various sources for a prescribed period of time, e.g. a day or a week. These program listings typically include for each program the title, a program description, the day of the week, the start time of the day, the program length, and the channel on which the program is transmitted and thus available for reception at source 100. In a preferred embodiment of the invention, the period of time for which the program listings are stored is different for the guides, depending upon viewer priorities and preferences. For example, the information may be stored for one or two days, or for a week or more.

Information relating to news stored in a news database of the EPG memory 145 includes but is not limited to new categories, news headlines, articles relating to the news headlines, graphical images associated with the articles, and links to television programs, Internet websites, and local guide information associated with each article.

Information relating to sports stored in a sports database of the EPG memory 145 includes but is not limited to sporting categories, sporting events in each sporting category, team information, scores, statistics, point spreads, and links to television programs, video clips, Internet websites, news articles, and local guide information associated with a sporting event.

Information relating to local events, businesses, products, and services (hometown information) stored in a hometown database of the EPG memory 145 include but is not limited to categories of such hometown information (e.g. movies, theater, restaurants), description of the hometown information, business, addresses, telephone numbers, graphical images related to the hometown information, and links to television programs, Internet websites, and news articles.

According to one embodiment of the invention, the links to television programs stored in the news, sports, and hometown databases include channel, date, time, and length information of a linked television program, or a pointers to an entry of such a program in the program schedule database. The links to Internet websites include URL information to particular web pages. The links to news articles and local guide information include pointers to such entries in the news and hometown databases.

An advertisement memory 146 coupled to the microprocessor 150 stores advertisement data to be displayed on the EPG as well as on the miniguide. Such advertisement data may include text, graphics, video clips, and the like. If an advertisement is for a future-scheduled television program, the advertisement data includes a pointer to an entry in the EPG memory storing the corresponding program schedule data. The advertisement data may be updated in any one of many conventional methods, including by a continuous data link in the vertical blanking interval (VBI) of a television channel broadcast to the television system 10. Although in the embodiment illustrated in FIG. 3, the EPG data and advertisement data are stored in separate memory devices, a person of skill in the art should realize that a single memory device may be used to store both types of data, whether it be in a single database or in separate databases.

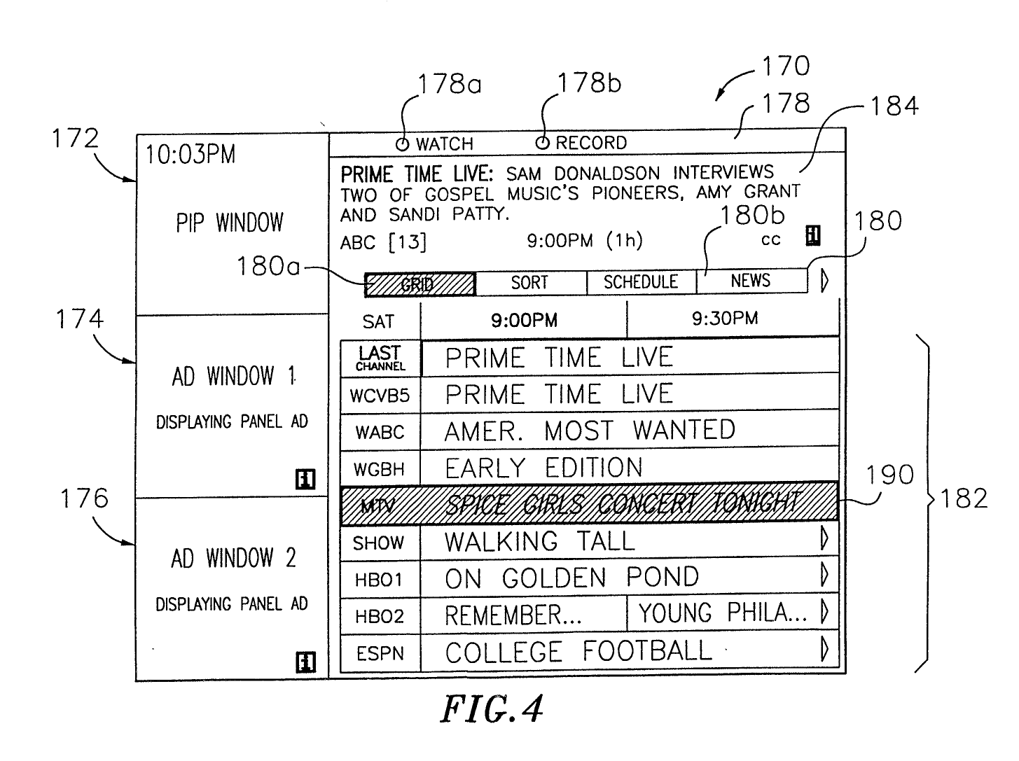

FIG. 4 is an illustration of an EPG screen 170 generated by the video processor 160 under the control of the microprocessor 150. The viewer invokes an EPG guide mode for displaying the EPG screen 170 by pressing a “guide” key on the viewer input device 40. The viewer returns to a full screen television mode by the same key or invoking a linked television program.

The EPG screen 170 is divided into a number of different display areas. A PIP window 172, a first panel ad window 174, and a second panel ad window 176 are arranged along the left side of screen 50. The remainder of the EPG screen 170 is typically occupied by an action key bar 178, a navigation bar 180, a grid guide 182, and an information box 184. In the embodiment illustrated in FIG. 4, the position of the windows, and other user interface features, including the action key bar 178, navigation bar 180 and grid guide 182, are fixed. In another embodiment of this invention, the position and size of the windows and other user interface features are customizable by the viewer.

The PIP window 172 displays real time broadcast programs or pre-recorded video clips produced by the PIP chip 140. A translucent overlay of the PIP window 172 can display a title, channel (local number and/or station name), and status (locked or unlocked) of the PIP window 172.

The first and second panel ad windows 174 and 176 display advertisements for future telecast programs or for products and services. An advertisement for a future telecast program is linked to a time and channel of the program allowing the viewer to watch or record the program automatically by highlighting the advertisement and pressing a watch action button 178a or a record action button 178b, respectively.

Highlighting an advertisement for a product or service allows the viewer to read one or more pages about the product or service from the information box 184. Alternatively, the advertisement is linked to a time and channel of an infomercial allowing the viewer to watch or record the infomercial by highlighting the advertisement and pressing the watch action button 178a or the record action button 178b, respectively.

The viewer accesses television program schedule information by actuating a grid button 180a from a list of menu buttons listed on the navigational bar 180. Upon actuation of the grid button 180a, the grid guide 182 displays a list of television programs with their respective channel designations 182a in a series of program tiles. According to one embodiment of the invention, the channel designations 182a indicate the corresponding signal source (e.g., cable, OTA, etc.) or the geographic region represented by the channel (e.g. local network station).

In addition to the program tiles, the grid guide 22 includes advertisement tiles 190 with virtual channel advertisements. A virtual channel ad may promote, for instance, a current or future television program. Such a virtual channel ad for a television program is linked to a time and channel of the program allowing the viewer to watch or record the program automatically.

The viewer may access news articles by actuation of a news button 180b from the navigational bar 180. Similar buttons may also be provided for accessing information about past, present, and future sporting events, and local information guide of a particular geographical area.

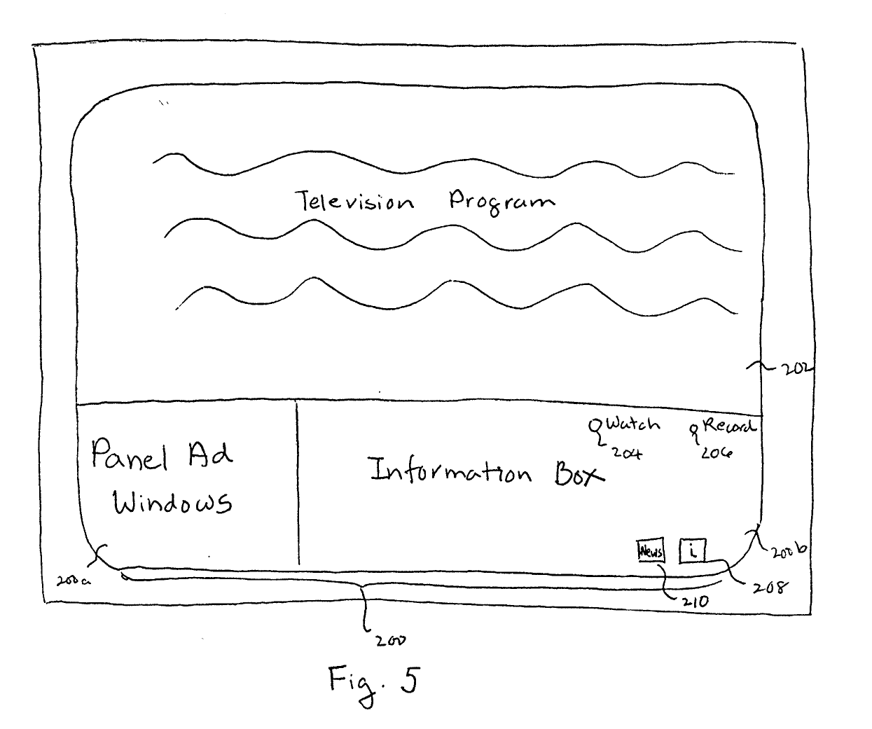

FIG. 5 is a schematic layout diagram of a miniguide 200 overlaid on a small area of a current television program 202 according to one embodiment of the invention. The miniguide includes at least one panel ad window 200a and an information area 200b. The panel ad window 200a occupies the lower left hand corner of the screen and is generally filled with paid advertisements of products/services or future programs. The information area 200b is located adjacent to the panel ad window 200a and occupies the lower right hand corner of the screen. The information area 200b provides detailed information of a current program being watched. Together, the panel ad window 200a and the information area 200b occupy the lower ⅓ of the screen.

The upper ⅔ of the screen is occupied by the current television program 202.

According to an alternative embodiment of the invention, a user may custom set the display of the miniguide in a setup window. In this regard, the user specifies various display settings such as the position and size of the miniguide, as well as other display criteria.

The viewer invokes the miniguide 200 while watching the television program 202 in full screen format by issuing a miniguide command using the viewer input device 40. This may be accomplished, for instance, by depressing an “INFO” key on the viewer input device 40 while watching the current television program 202. The command is transmitted to the microprocessor 150 which initiates a miniguide program stored in memory.

The miniguide program retrieves from the EPG memory 145 the title and short description of the current program 202, as well as its start time and duration. The retrieved information is then displayed in the information area 200b of the miniguide. The displayed information is deemed to be a first level of information when multiple levels of information, each level with additional program information, are available for the current program 202.

The existence of additional levels of information is preferably indicated by an information icon 208 in the information area 200b. The additional levels of information may be viewed by depressing the “INFO” key again. The miniguide program retrieves the more detailed information about the current program 202 from the EPG memory 145 and displays it in the information were 200b, in a partial-screen window on top of the current television program, or a full-screen window that replaces the television program.

The user may further schedule to watch or record future rebroadcasts of the current television program 202 directly from the miniguide 200. The user selects a watch action button 204 to schedule the watch, or a record action button 206 to record the future rebroadcast.

In addition to the above, the program-related information displayed on the information area may also contain links to a public network such as the Internet, and to other information available through the EPG. For instance, the miniguide 200 may provide links to related news articles in the news database, sports-related information in the sports database, and local events and business information in the hometown database. A user is alerted about a link via visual or audio indicators provided in the information area 200b. For instance, a news article icon 210 may be inserted in the information area to alert the user as to the existence of a related news article. The linked article is then displayed to the user in the information area 200b, in a separate partial-screen window on top of the current television program, or in a full-screen window that replaces the television program.

The miniguide 200 further retrieves advertisement data from the advertisement memory 146 and displays it on the panel ad window 200a. According to one embodiment of the invention, advertisements are based on the current program being watched. For instance, if the viewer is watching a football game, a sports-related advertisement is displayed on the panel ad window 200a.

In an alternative embodiment, advertisements are customized based on the viewer's profile information. The creation and analysis of viewer profile information is described in detail in U.S. Application Ser. No. 09/120,488, the contents of which are incorporated herein by reference. Briefly, every time the viewer interacts with the television, miniguide, EPG, Internet, and any other sources of information external to the EPG, the EPG records the viewer's actions and the circumstances surrounding those actions. For instance, when the viewer changes channels, the EPG records, among other things, information about the first channel, the changed-to channel, the time that the change was made, the identification of the programming that was displayed on the first channel, the identification of the programming that was displayed on the changed-to channel, the time of the change, the identification of any advertisement that was displayed on the first channel at the time of the change, the identification of any advertisement that was displayed on the changed-to channel, and whether the viewer changed channels while in one of the EPG modes, as opposed to being in the television mode.

The EPG also records every instruction by the viewer to record or watch a program. The EPG further records whether the viewer changes the volume of the television audio, and if so, what circumstances surrounded the change in volume.

If the viewer changes channels while in one of the EPG modes, the EPG records information about what was displayed in each of the windows of the EPG before and after the change.

The EPG also records information when there is an absence of interaction between the viewer and the television or the EPG. For instance, the EPG records whether a viewer continues to view an advertisement rather than changing channels. The EPG calculates and records the entire duration of the time that the television is on in any particular day.

The EPG also records information surrounding the viewer's interaction with external sources of information, such as the Internet. For instance, the EPG records each search query criteria initiated by the viewer, the Search Engine used to make the search, the items selected by the viewer from the search response, interaction by the user with Internet sites, and viewer interactions with the EPG during the same time-frame as the viewer interacts with the Internet.

The EPG accumulates and analyzes the viewer profile information and selects an advertisement for display on the panel ad window. The viewer preferably interacts with the advertisement directly from the miniguide 200 as he or she would from the full screen guide while watching the current television program 202. For instance, the viewer may highlight the advertisement resulting in an automatic display of ad-related information in the information area 200b. For example, for product-related advertisements, highlighting the advertisement may trigger the display of information about the product and/or cause the display of a video clip of the product. The viewer may purchase the product in the highlighted advertisement by transmitting a purchase command from the viewer input device 40. In one embodiment of the invention, the purchase information is transmitted via a back channel to a collection house or specific retailer who processes the purchase request and delivers the product to the viewer.

In another embodiment of the invention, highlighting an advertisement causes the display of a link to a related Internet site in the information area 200b. Selection of the link causes the television system 10 to connect to the Internet by telephone line via modem, by cable modem, or by any other conventional method of communicating with the Internet, including a wireless modem.

The advertisement displayed on the panel ad window 200a may further relate to a currently broadcast or future broadcast television program. A viewer may tune directly to the currently broadcast program advertised on the panel ad window by highlighting the advertisement and transmitting an Enter/Select command from the viewer input device 40. The viewer may further record or place the program into a watch schedule by selecting the watch action button 204 or the record action button 206, respectively, directly from the miniguide.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by the appended claims and their equivalents.

1. A method for displaying television schedule information in a television system including a television having a display screen, the method comprising:
displaying a television program on the screen in a full screen format;
displaying a portion of the television schedule information associated with the television program on a first area of the screen; and
displaying an advertisement on a second area of the screen located horizontally adjacent to the first area;
wherein the portion of the information in the first area and the advertisement in the second area are invoked concurrently and overlaid on a portion of the television program in response to a user command.

2. The method of claim 1, wherein the first and second areas occupy about ⅓ of a total area of the screen.

3. The method of claim 1, wherein the position and size of the first and second areas are customized by a user.

4. The method of claim 1, wherein the television schedule information is organized in plurality levels of detail, and the first area of the screen initially displays a first level of detail.

5. The method of claim 4, wherein additional layers of detail are displayed in the full screen format.

6. The method of claim 1, wherein the advertisement is based on the television program.

7. The method of claim 1, wherein the advertisement is customized based on a viewer profile.

8. The method of claim 1 further comprising:
highlighting the advertisement; and
activating a function with respect to the highlighted advertisement.

9. A television system for displaying television schedule information, the system comprising:
a television screen including a first area and a second area located horizontally adjacent to the first area;
means for invoking a first mode for displaying a television program on the screen in a full screen format; and
means for invoking a second mode for displaying a portion of the television schedule information associated with the television program on the first area and an advertisement on the second area, the portion of the information and the advertisement being overlaid on a portion of the television program and displayed concurrently with the television program.

10. The system of claim 9 further comprising means for customizing the position and size of the first and second areas.

11. The system of claim 9 further comprising means for selecting the advertisement based on the television program.

12. The system of claim 9 further comprising means for customizing the advertisement based on a viewer profile.

13. The system of claim 9 further comprising:
means for highlighting the advertisement; and
means for activating a function with respect to the highlighted advertisement.

14. A television system for displaying television schedule information, the system comprising:
a television screen including a first area and a second area located horizontally adjacent to the first area;
a tuner coupled to the television screen for displaying a television program in a full screen format;
a memory coupled to the television screen for storing the television schedule information;
a viewer input device for providing user commands;
a processor coupled to the viewer input device and the memory, the processor being operable to execute program instructions including displaying in response to the user command a portion of the television schedule information associated with the television program on the first area and an advertisement on the second area, the portion of the information and the advertisement being overlaid on a portion of the television program and displayed concurrently with the television program.

15. The system of claim 14, wherein the program instructions further include selecting the advertisement based on the television program.

16. The system of claim 14, wherein the program instructions further include customizing the advertisement based on a viewer profile.

17. The system of claim 14, wherein the program instructions further include:
highlighting the advertisement; and
activating a function with respect to the highlighted advertisement.
